(19) United States
(12) Patent Application Publication
(10) Pub. No.: US 2008/0276501 A1
(43) Pub. Date: Nov. 13, 2008

(54) LUGGAGE IDENTIFICATION SYSTEM

(76) Inventor: Pamela Fetters, Phoenix, AZ (US)

Correspondence Address: JENNINGS, STROUSS & SALMON, P.L.C., 201 E. WASHINGTON ST., 11TH FLOOR, PHOENIX, AZ, 85004, US

(21) Appl. No.: 12/117,587

(22) Filed: May 8, 2008

Related U.S. Application Data
(60) Provisional application No. 60/916,901, filed on May 9, 2007.

(51) Int. Cl. G09F 3/20; G09F 3/02; G08B 13/14

(52) U.S. Cl. 40/6; 40/651; 340/572.8

(57) ABSTRACT

A luggage identification system that is somewhat uniform in its design, but may be personalized by the passenger to uniquely identify their luggage. The luggage identification system may include a display strap, an identifying graphic, and a fastening device. The luggage identification system is constructed so that it tends to stand up and away from the bag like a flag, so that it remains visible from a distance. Since customization of a graphic device is provided the visible luggage identification system may be recognized by the passenger and retrieved by them. The luggage identification system is also of sufficient strength and shape to act as a handle for retrieving the luggage, which tends to be useful as the passenger may naturally tend to reach for what they recognize.

### CROSS-REFERENCE TO RELATED APPLICATION

This application claims the benefit of U.S. Provisional Patent Application No. 60/916,901 filed May 9, 2007, the contents of which are hereby incorporated by reference.

### TECHNICAL FIELD

This description relates generally to identification of items and more specifically to the identification of luggage.

### BACKGROUND

Identifying ones baggage or other articles can often be difficult. Similarly identifying people in a crowd can also be difficult. Many suit cases look alike, and are often of the same color, which can often be black. This is typically not a problem when traveling alone or with ones bags stored in an overhead bin. However, when taking advantage of mass transportation, such as airline flights where bags are checked, and later delivered to a carousel with everyone else's bags identification can be a problem. People often see a bag they think is theirs, and rush up to the carousel to find that on closer look it is not theirs. Sometimes bags are retrieved and examined and then returned to the carousel after a numbered tag is read. Sometimes, the wrong bag goes home with the wrong person.

Passengers have sometimes used name tags, and even tied colored string to their bags to distinguish them so that their owners can identify and retrieve them. However, these efforts often lack sufficient visibility for immediate identification. In particular luggage tags tend to be the same color, are typically only big enough to hold a business card, and lay flat against the bag. A passenger must often retrieve the bag and look at the tag to determine if the bag is his.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a luggage identification system that is somewhat uniform in its design, but may be personalized by the passenger to uniquely identify their luggage. The luggage identification system may include a display strap, an identifying graphic, and a fastening device. The luggage identification system is constructed so that it tends to stand up and away from the bag like a flag, so that it remains visible from a distance. Since customization of a graphic device is provided the visible luggage identification system may be recognized by the passenger and retrieved by them. The luggage identification system is also of sufficient strength and shape to act as a handle for retrieving the luggage, which tends to be useful as the passenger may naturally tend to reach for what they recognize.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a diagram of an example of the luggage identification system coupled to a suitcase.

FIG. 2 is a diagram showing further detail of the luggage identification and its coupling to an exemplary suitcase handle.

FIG. 3 is a diagram showing the display strap of the luggage identification system.

FIG. 4 is a diagram showing the identifying graphic of the luggage identification system.

FIG. 5 is a diagram showing the fastening device of the luggage identification system.

FIG. 6 is a flow diagram showing a process for providing a luggage identification system.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe an luggage identification system. Although the present examples are described and illustrated herein as being implemented in a baggage retrieval system, the system described is provided as an example and not a limitation. As those skilled in the art will appreciate, the present examples are suitable for application in a variety of different types of identification systems, such as the identification and pairing of owners to belongings, people to a group, people to a location, or the like.

In the case of a typical luggage carousel the belt can have a speed of approximately 90 feet per minute. With this rate of travel it may be useful to provide a luggage identification that may be identifiable from over 22 feet away so that the bag may be identified from this distance, and its owner can get to it and claim it before it passes beyond reach. The size of the luggage identification system and its flag like display help to provide the appropriate visibility under these conditions.

The present example provides a luggage identification system that is somewhat uniform in its design, but may be personalized by the passenger to uniquely identify their luggage. The luggage identification system may include a display strap, an identifying graphic, and a fastening device. The luggage identification system is constructed so that it tends to stand up and away from the bag like a flag, so that it remains visible from a distance. Since customization of a graphic device is provided the visible luggage identification system may be recognized by the passenger and retrieved by them. The luggage identification system is also of sufficient strength and shape to act as a handle for retrieving the luggage, which tends to be useful as the passenger may naturally tend to reach for what they recognize.

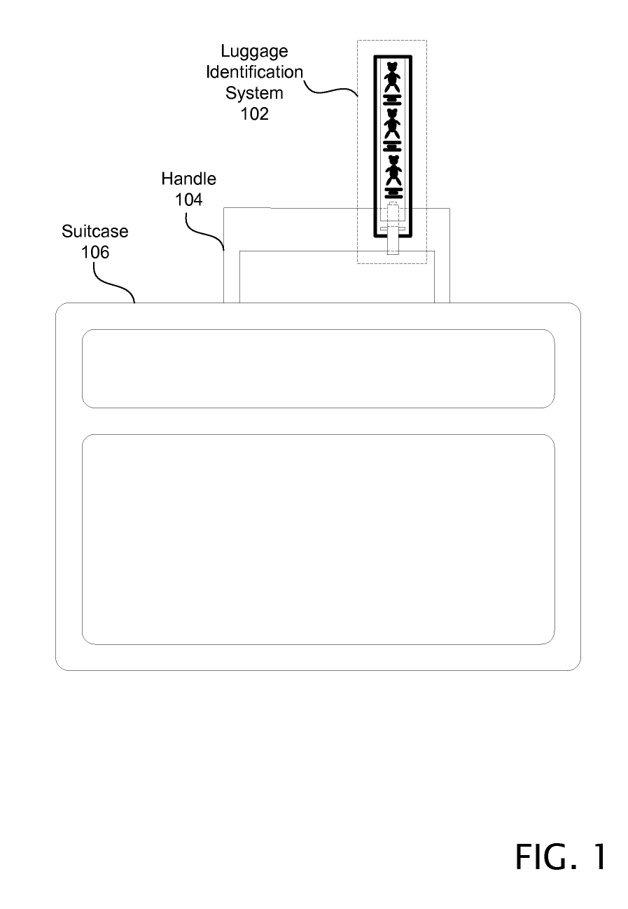

FIG. 1 is a diagram of an example of the luggage identification system 102 coupled to a suitcase 106. As shown an example of the luggage identification system 102 can be coupled to a handle 104, of an exemplary suitcase 106. The handle 104 is exemplary only and the luggage identification system 102 may couple to other equivalent structures. The suitcase 106 is exemplary only, as a handle 104 (or its equivalent) may be present on a variety of objects that may be suitable for use with the luggage identification system 102.

As can be seen in the diagram the luggage identification system 102 stands erect and away from the suitcase 106 in a flag like manner tending to make the suitcase 106 easily identifiable. The size of the luggage identification system, in combination with a unique graphics device that is part of the luggage identification system tends to help with identification of the suitcase 106. Suitcase 106 is typical of the many types of bags that may be present on a baggage carousel. They typically appear to be similar in size, shape and color. Common characteristics that do not lend to the easy identification of one's particular suitcase while they are in motion on a baggage carousel. However the luggage identification system tends to promote visibility and identification of one's luggage. In addition one or more luggage identification systems may be affixed to the bag to distinguish the bag if the other tag tends to be obstructed.

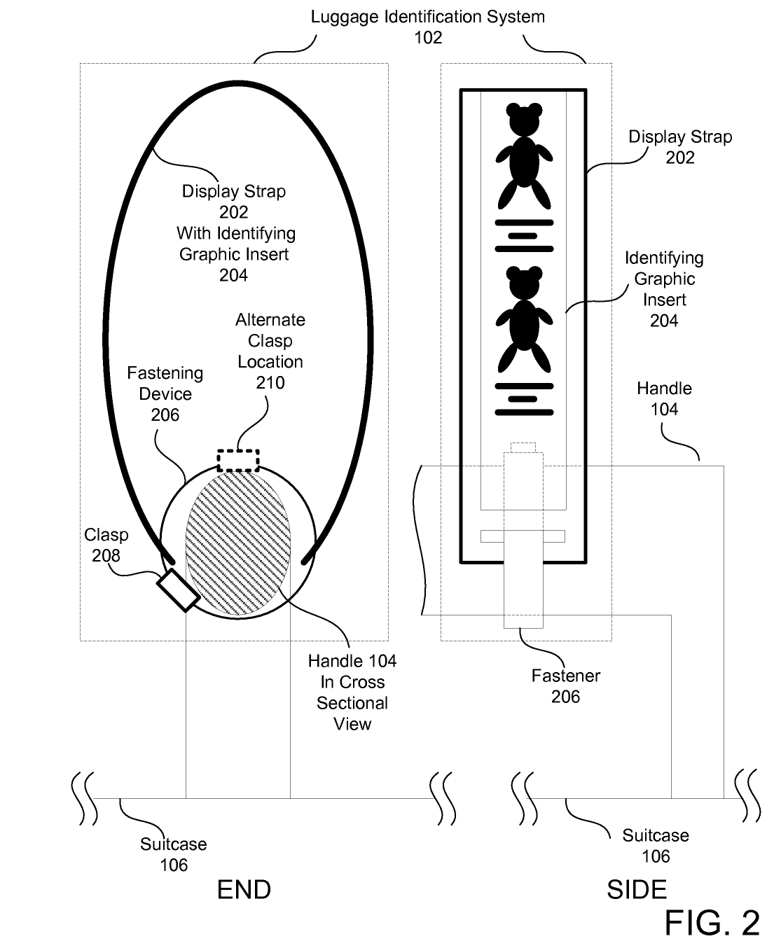

FIG. 2 is a diagram showing further detail of the luggage identification system 102 and its coupling to an exemplary suitcase handle 104 of a suitcase 106. In alternative examples parcels, briefcases or the like may be substituted for the suitcase 106. The luggage identification system may be utilized with any object that one wishes to easily identify. Also the handle 104 may be substituted by any suitable object suitable for coupling the luggage identification system 102 to. Front and side views are shown. The luggage identification system 102 may include an identifying graphic insert 204 disposed in a display strap 202, and coupled to a handle 104 by a fastening device 206. As shown in the side view the luggage identification system 102 is coupled to a handle 104 with the fastener 206 so that the luggage identification system 102 tends to stand upright in a flag like manner.

The display strap 202 may be made from a durable and flexible material so that it may be bent, twisted, or otherwise deformed without damage. The display strap 202 may also be sufficiently transparent so that the identifying graphic insert 204 may be seen. In further alternative examples the display strap may have a sufficiently sized cavity so that three dimensional object or graphics may be disposed within the display strap 202.

The fastener 206 is typically flexible enough to conform to the shape of the handle 104 and secure opposite ends of the display strap against the handle to position the luggage identification system on the handle and allow it to remain in an upright, or flag like position.

As seen in the end view the display strap 202 with identifying graphic insert 204 form a loop when the ends are secured to the handle 104 by the fastening device 206. Securing the ends in this manner also tends to keep the identifying graphic insert disposed within the display strap 202 and otherwise preventing it from slipping out. The loop formed may act as a handle for retrieving the suitcase 106, once its owner identifies it.

The fastening device 206 may include a clasp 208 which may be disposed at various alternate locations 210 for appearance considerations or to aid in assembly of the luggage identification system 102. The clasp 208 may include a release so that the fastening device 206 may be disengaged or removed if desired. For example removal may be desired so that the identifying graphic insert 204 may be removed, or changed. Alternative examples of fastening devices may be provided that need not encircle the handle 104. For example screws, staples rivets, adhesive or the like may be used individually or in combination to secure the display strap ends to the handle 104. In further alternative examples a slot may be disposed in the handle to accept insertion of the display strap ends with the strap secured in the slot by a screw or other equivalent fastener. Alternatively the strap ends may be gathered at one side of the handle so that the display strap forms a loop.

In further alternative examples identification may be aided by the addition of a conventional RFID device, a conventionally constructed LED, or other light emitting system that responds in a unique manner when the suitcase owner approaches with a matching transceiver, or otherwise signals the tag to respond. In further alternative examples the luggage identification system 102 may be equipped with a conventionally constructed audio circuit to produce an audio tune when the owner signals or approaches. Alternatively a conventional digital recording circuit may be included with the transponder so that a recorded message may be played when the owner signals or approaches. Such circuits may be conventionally constructed in a compact manner utilizing integrated circuit technology including polymer transistors, LEDs, silicon based circuits or the like.

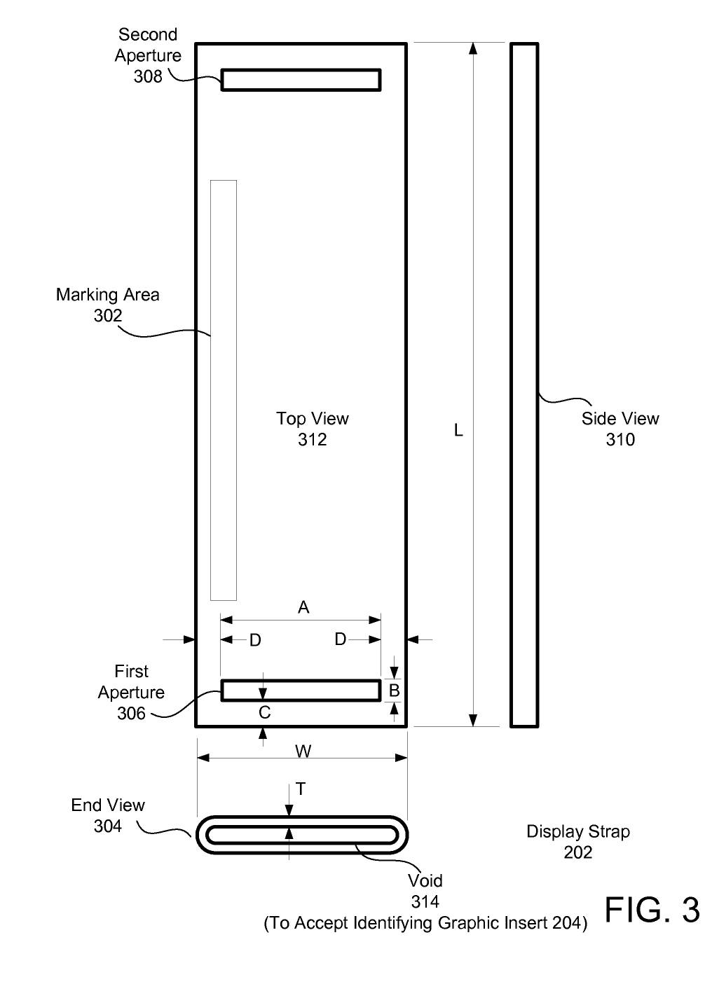

FIG. 3 is a diagram showing the display strap 202 of the luggage identification system. An exemplary display strap 202 may be made of Flexible Polyvinyl Chloride (“FPVC”) or an equivalent flexible and durable material. FPVC may be a versatile material ranging from soft, flexible to semi-rigid, and may be used for tubing or the like. It is available in industrial or FDA grades. The material may be clear, semi opaque, fluorescent, or otherwise tinted or colored to aid in identification. However, sufficiently transparency should be provided to allow visibility of the graphic insert.

Raw FPVC material, such as the exemplary FPVC70, may be supplied as a flattened tube structure of a given width (“W”) as shown in the end view 304. Such a structure may include a void, or longitudinal opening, 314 in which the identifying graphic insert (not shown) may be disposed. The material typically has a sufficient wall thickness (“T”) to provide sufficient rigidity and flexibility for the given material. As seen in the top view 312 the flattened tube material may be cut or formed to length (“L”), with a marking area 304 designated so that part numbers, or other identifying information may be printed, stamped, laser marked or otherwise disposed on the display strap 202.

A first aperture, or slot, 306, and a second aperture, or slot, 308 may be disposed at opposite ends of the display strap 202. Although the apertures 306, 308 are shown as rectangular having a width (“A”) and a height (“B”), other equivalent aperture shapes may be used that facilitate fit and manufacture. For example shapes that conform to conventional die cut openings may be utilized. The aperture is typically centered between the sides of the display strap (“D”), and is positioned (“C”) an appropriate distance from the ends of the display strap to provide sufficient strength to prevent tearing of the apertures 306, 308 when the display strap may be used as a handle.

The side view 310 shows a uniform edge, however other decorative shapes may be formed on the edge, such as scallops, zigzags and the like. In further alternative examples LEDs may be formed into the plastic to provide any desired pattern, or a grid array of LEDs may be disposed in the display strap material so that custom displays may be generated.

In an example of the display strap 202 the following dimensions may be provided: L=16 inches, W=2 inches, T=0.060 inches, A=1 inch, B=0.025 inches C=0.5 inches and D=0.5 inches. The dimensions are only exemplary of one configuration. In alternative examples other dimensions may be utilized.

In alternative examples of the FPVC strap, materials equivalent to FPVC may be used. In further alternative examples of the strap the various other dimensions may be varied as well. For example the length (shown as 16″), the width (shown as 2″), the slot width (shown as 1″), and the placement of the slot (shown centered may also be varied. In addition the slot may be positioned at various distances from the edges of the strap such that the FPVC display strap tends not to tear when it is used as a handle. In addition the slot may be provided in other equivalent configurations, including a slot with rounded corners, an oval, a circle, or the like. In short any convenient shape that may be punched or otherwise let into the FPVC strap material. The thickness of the FPVC strap material may also be similarly varied in order to provide strength as a carrying handle, and/or to make the strap stand up as desired.

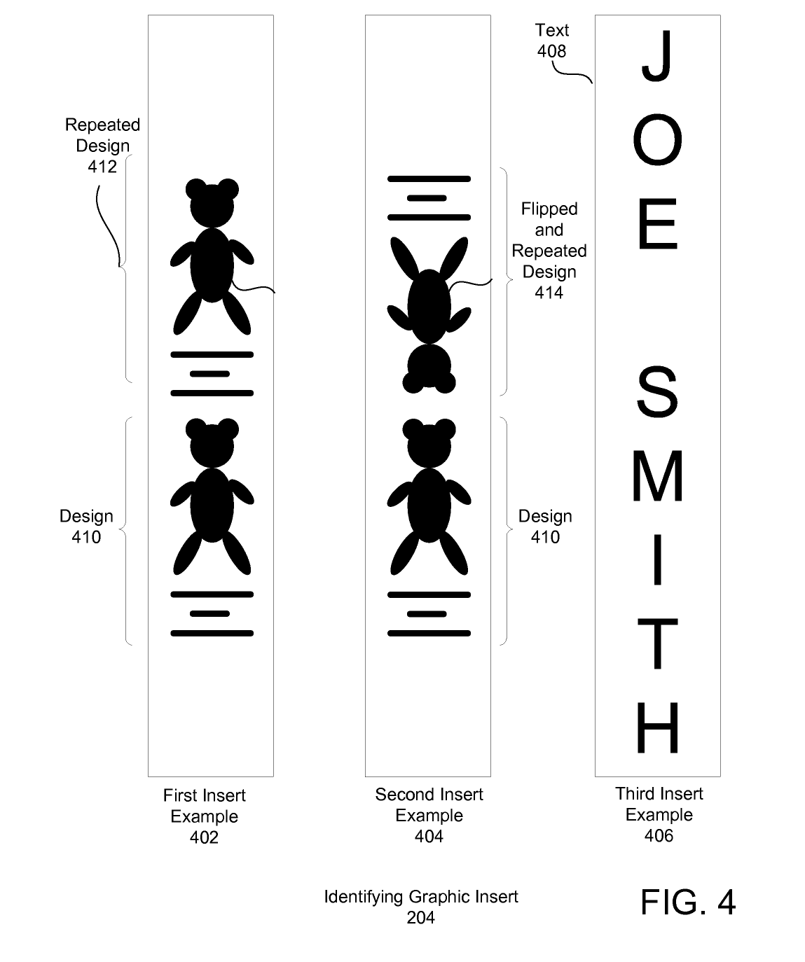

FIG. 4 is a diagram showing the identifying graphic insert 204 of the luggage identification system. A plurality of graphics may be provided with three representative examples 402, 404, 406 shown. The graphic may be any type of picture, bar code, magnetic stripe, device, symbols, patterns, letters, colors, lines, shapes, business card, promotional item, or the like. The graphic may also include any combination of the previously mentioned device, symbols, patterns, letters, colors, lines, shapes, or the like. The graphic is typically disposed upon paper, mylar, or any suitable substrate, and the graphic may be disposed on one or both sides of the substrate. The substrate may be of clear, white, or any suitable color pattern, or combination of patterned stock. The graphic may be hand drawn, hand lettered, machine generated or created by any desired way by the bag owner. Alternatively preprinted graphic inserts 204 may be provided. In an example, promotional materials or devices may be preprinted on the graphic insert, with space left for user customization. Alternatively a website or computer rendering program may be configured to print or otherwise create the graphic insert 204.

In the three examples shown 402, 404, 406, graphic and text designs are shown. The graphic may be one unitary design, or as shown in the first example 402 a graphic design 410 is disposed on the substrate and stepped and repeated 414. In the second example of an insert 404 the design 410 has been flipped and repeated 414, so that it may appear upright when viewed from either side when disposed in the luggage identification system 102. In the third insert example 406 text 408 is provided as the graphic.

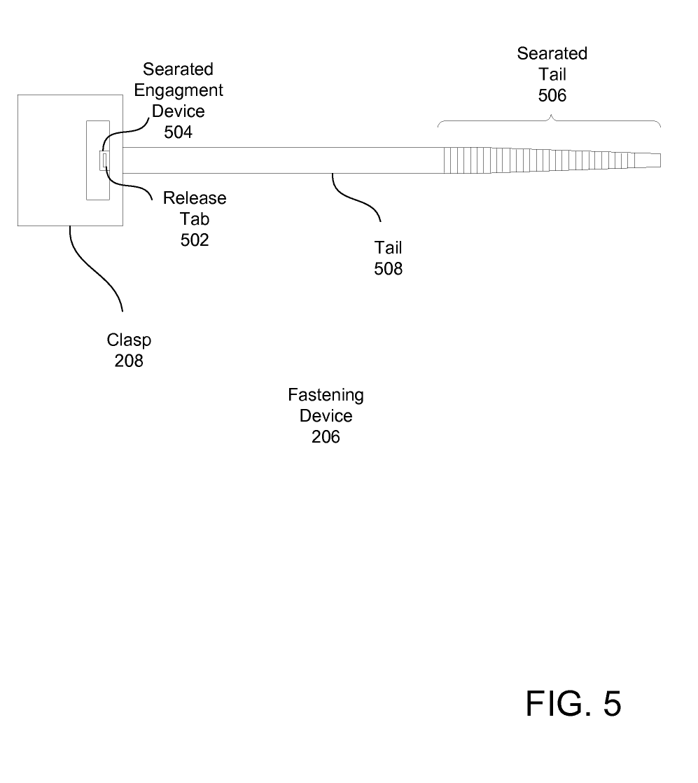

FIG. 5 is a diagram showing the fastening device 206 of the luggage identification system. The fastening device shown is a conventionally constructed cable tie. The tail 508 is of sufficient width to fit into an aperture disposed in the display strap (not shown). The cable tie shown includes a conventionally constructed release tab 502. however in alternative examples cable ties without a release mechanism may be used. The serrated engagement device 504 typically engages the serrated tail 506 when it is inserted in the clasp 208. Equivalently a VELCRO™ strap or equivalent fastening device 206 may be substituted for the cable tie fastening device 206 shown. The Velcro fastener is typically formed from conventional Velcro tape of sufficient length to attach the FPVC display strap to a luggage handle so that the strap tends to stand upright. The Velcro fastener may be provided in widths corresponding to the slot width in the display strap. Alternatively other slot widths and Velcro widths may be supplied. A Velcro fastener may also be used to fasten the FPVC strap to the wrist of a child, or other valuables.

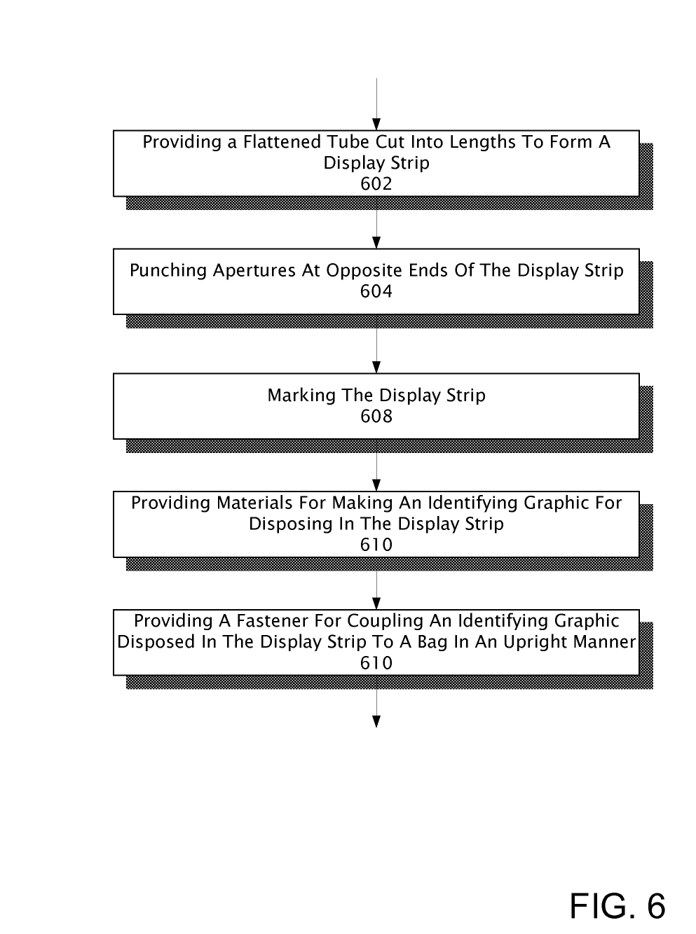

FIG. 6 is a flow diagram showing a process for providing a luggage identification system. At block 602 a flattened FPVC tube or its equivalent is provided, which is cut into lengths, forming a display strip. At block 604 apertures are disposed or punched at opposite ends of the display strip. At block 608 the display may be marked in this optional process. At block 610 materials are provided for making the identifying graphic insert, that may be disposed in the display strip. and finally at block 610 a fastener is supplied for coupling the identifying graphic disposed in the display strip to a bag, or object in an upright and visible manner.

The system typically includes a display strap, an identifying graphic, and a fastener. The luggage identification system when coupled to a handle of a suit case, (or its equivalent) tends to stand up for to show off the identifying graphic so the exemplary luggage may be retrieved. When coupled to the exemplary handle in the manner provided the luggage identification also tends to provide a sturdy strap to aid in the retrieval of the tagged item.

Those skilled in the art will realize that the process sequences described above may be equivalently performed in any order to achieve a desired result. Also, sub-processes may typically be omitted as desired without taking away from the overall functionality of the processes described above.

1. A identification system comprising:
a display strap;
an identifying graphic insert disposed in the display strap; and
a fastening device for coupling the display strap with the graphic insert to an object.

2. The identification system of claim 1, in which the display strap is made from FPVC material.

3. The identification system of claim 1, in which the display strap is formed in the shape of a flattened tube.

4. The identification system of claim 1, in which the fastening device prevents the identifying graphic from coming out of the display strap.

5. The identification system of claim 1, in which in which the display strap with the identifying graphic insert forms a flexible loop.

6. The identification system of claim 1, in which in which the fastening device is a cable tie.

7. The identification system of claim 1, in which in which the fastening device includes a release mechanism.

8. The identification system of claim 1, in which in which the graphics insert is user customizable.

9. The identification system of claim 1, in which in which the graphics insert is computer generated.

10. A luggage identification system comprising:
a clear and flexible FPVC strap having an opening;
an identifying graphic disposed on a substrate, and disposed in the opening; and
a releasable fastener for coupling a first aperture, and a second aperture to a handle.

11. The luggage identification system of claim 10, in which the clear and flexible FPVC strap is made from tinted FPVC material.

12. The luggage identification system of claim 10, in which the substrate is paper.

13. The luggage identification system of claim 10, in which the substrate is mylar.

14. The luggage identification system of claim 10, further comprising an RFID device disposed in the opening.

15. The luggage identification system of claim 10, further comprising an RFID device coupled to the substrate and disposed in the opening.

16. The luggage identification system of claim 10, in which the clear and flexible FPVC strap forms a loop.

17. The luggage identification system of claim 10, in which the releasable fastener prevents the clear and flexible FPVC strap from moving.

18. A method of constructing a luggage identification system comprising:
cutting a flattened tube to length to form a length of flattened tube;
disposing apertures at opposite ends of the flattened tube to create a display strip;
providing a substrate for creating an identifying graphic; and
providing a fastener for coupling the display strip to a handle.

19. The method of constructing a luggage identification system further comprising marking the length of flattened tube.

20. The method of constructing a luggage identification system further comprising disposing an RFID device in the display device.
